(19) United States
(12) Patent Application Publication
(10) Pub. No.: US 2002/0005174 A1
(43) Pub. Date: Jan. 17, 2002

(54) Safety leash

(76) Inventor: Uwe Meissner, Grossniedesheim (DE)

Correspondence Address: The Law Office of Clifford F. Rey, 853-I Wake Forest Business Park, Wake Forest, NC, 27588-1555, US

(21) Appl. No.: 09/835,309

(22) Filed: Apr. 16, 2001

(30) Foreign Application Priority Data
Jul. 17, 2000 (DE) 200 12 514.1

(51) Int. Cl. A01K 27/00

(52) U.S. Cl. 119/795

(57) ABSTRACT

A safety leash for an animal such as a dog which functions to control the dog at a fixed distance from its handler for training and safety purposes is disclosed. The present safety leash comprises an elongated rod or tubular member, which extends between a handgrip at one end and a collar fastener at an opposite end thereof for connecting to the collar of the dog or other animal. The rod or tubular member is constructed of a rigid material such as aluminum or plastic of a predetermined length. The rod or tubular member is provided with an external sheath of a durable, tear-resistant material suitable for this purpose. When the dog or other animal suddenly pulls on the leash, its movement is restrained by the length of the rigid rod or tubular member and the animal is maintained at a fixed distance from its handler. The safety leash may also be utilized as a training aid in teaching the animal desirable leash walking habits.

### CROSS-REFERENCE TO RELATED APPLICATION

This Application claims foreign priority benefits under 35 U.S.C. § 119(a)-(d) to German Patent Application No. 200 12 514.1 filed Jul. 17, 2000, by inventor, Uwe Meissner, for an invention entitled, “Hundeleine”.

### BACKGROUND OF THE INVENTION

### Field of the Invention

The present invention relates to animal leashes and, more particularly, to a dog safety leash, which functions to control a dog at a fixed distance from the dog handler and also to teach desirable leash walking habits.

Many different types of dog leashes are well known in the prior art and have been provided in different forms for a variety of purposes. Typically such leases are comprised of a flexible, but inelastic cord of a fixed length including a hook or other fastening element at one end for attachment to the animal's collar and a handgrip at an opposite end for grasping by the dog's handler. Other so-called retractable leashes are adjustable in length and capable of being retracted into a small housing by a conventional spring mechanism. Such leashes function adequately for purposes of the average pet owner.

However, there are dog breeds, which in certain situations exhibit aggressive behavior toward unfamiliar persons, other animals, and even to the dog handler who is leading the dog on the leash. The leashes known in the prior art have the essential disadvantage that a fixed distance between the animal and the dog handler cannot be maintained during such aggressive behavior of the animal.

Thus, the present invention has been developed to provide an animal safety leash that permits the owner/dog handler to maintain the animal at a controlled distance during an episode of aggressive behavior for purposes of training and safety.

### DESCRIPTION OF RELATED PRIOR ART

One example of a prior art dog leash is disclosed in U.S. Pat. No. 6,053,129 to Akre, which discloses an animal walking leash apparatus for dogs and other animals that utilizes a length of elastic, stretchable, bungee-type cord anchored to and carried within a substantially rigid, hollow tube member having a hand grip portion with a safety wrist snap, the forward end of the elastic cord member mounting a collar fastener for connection to the collar of a dog to be walked such that the jerks and pulls of the animal are accommodated in shock-absorbing fashion by the leash to the benefit and comfort of both operator and animal.

Another example of a prior art dog leash is disclosed in U.S. Pat. No. 6,053,128 to McCulloch which discloses a safety leash for an animal including an elongate flexible strap having opposite first and second ends. The first end of the flexible strap is looped through the attachment ring of a first clip member. An elongate secondary strap having a pair of opposite end portions is coupled to the flexible strap. The secondary strap is looped through the attachment ring of a second clip member.

### SUMMARY OF THE INVENTION

Accordingly, the present invention provides an animal safety leash, which allows the owner/handler to maintain an animal such as a dog at a fixed distance in crowded areas and/or during episodes of aggressive behavior to prevent injury to other persons, animals, or to the dog handler. The present safety leash comprises an elongated rod or tubular member, which extends between a handgrip at one end and a collar fastener at an opposite end thereof for attachment to the collar of the animal. Preferably the rod or tubular member is constructed of metal or other inflexible material such as plastic of a predetermined length. The rod or tubular member is provided with an external sheath of a durable, tear-resistant material suitable for this purpose. For example, the sheath may be constructed of a woven fabric, leather or other suitable material.

When the dog or other animal pulls or suddenly takes off, its movement is restrained by the length of the rigid rod portion of the leash and the animal is maintained at a fixed distance from its handler. Further, the present safety leash may be utilized by the handler to teach the dog proper leash walking habits or other desirable behaviors. For example, the dog may be trained to lie on the ground by the exertion of a downward force on its collar using the rigid leash with a command from the handler.

As the result of the foregoing basic concept, the principal object of the present invention is achieved; namely the provision of an animal safety leash, which enables the increased control of an animal such as a dog at a fixed distance from the handler to prevent injuries to other persons, animals, and the handler in crowded areas and/or during episodes of aggressive behavior.

Another object of the present invention is to provide a rigid animal safety leash of a durable construction which may be utilized as a training aid in the animal's learning of desirable leash walking habits and behaviors.

Other features and technical advantages of the present invention will become apparent from a study of the following description and the accompanying drawings.

### BRIEF DESCRIPTION OF THE DRAWINGS

The novel features of the present invention are set forth in the appended claims. The invention itself, however, as well as other features and advantages thereof will be best understood by reference to the following detailed description of an illustrative embodiment when read in conjunction with the accompanying figures, wherein:

FIG. 1 is a cross-sectional view of one embodiment of an animal safety leash embodying features of the present invention showing details of the construction thereof; and

FIG. 2 is a side elevational view of the animal safety leash showing additional features thereof.

### DETAILED DESCRIPTION OF THE PREFERRED EMBODIMENT

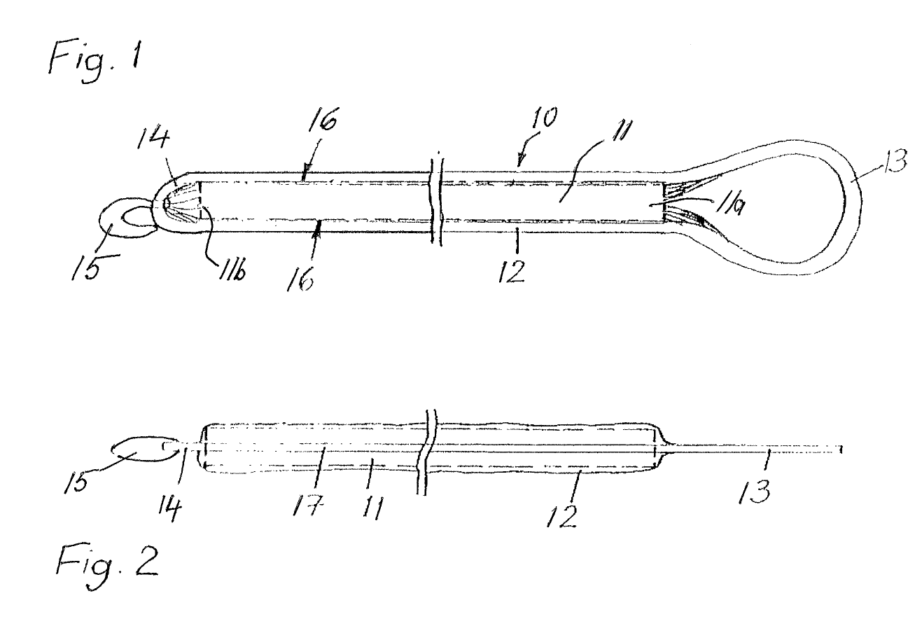

With further reference to the drawings there is shown therein an animal safety leash in accordance with the present invention, indicated generally at 10 and illustrated in FIG. 1. As shown in the drawing, the safety leash 10 includes an elongated tubular member 11 formed of a predetermined length of a rigid material such as tubular aluminum, plastic, or other synthetic material having suitable mechanical and physical properties for this application. In the embodiment shown the tubular member 11 includes a proximal end 11 a and an opposite distal end 11b.

The actual length of the leash 10 and, accordingly, the tubular member 11 may vary for a particular animal, but is generally in the range of 12″-36″ for common breeds of dogs depending on the size, weight, strength and other such factors.

FIG. 1 shows a simple embodiment, which is both effective and easy to manufacture and assemble. In this arrangement the tubular member 11 is encased in a generally cylindrical sheath 12, which closely conforms to the outer surface of the tubular member 11 as shown in the drawings. In the preferred embodiment the sheath 12 is fabricated from a flexible, tear-resistant material such as leather, vinyl, woven fabric, or other suitable material. The sheath 12 is sewn along its length forming a longitudinal seam 17 as shown in FIG. 2.

The sheath 12 includes an integrally formed handgrip or loop 13 at proximal end 11a thereof for gripping by the handler during use. The opposite distal end 1b of the safety leash 10 includes a spring-actuated safety hook 15, which is mechanically coupled to the present safety leash 10 by means of a reinforced loop or ring 14 secured to the distal end 11b of the tubular member 11 and which extends through the sheath 12 as seen in FIG. 2. Although a particular reinforced loop or ring 14 arrangement is shown herein, it is known to those skilled in the art that many other equivalent structural arrangements alternatively may be provided to engage the loop or ring 14 with the tubular member 11 for the described purpose.

The present safety leash 10 is intended for use in circumstances in which it is necessary to restrict the range of movement of an animal such as a dog temporarily for increased control. For example, when walking the dog in congested areas such as busy sidewalks, veterinarian offices, close to automobile traffic and other circumstances when it is desirable to keep the dog under close control.

In practical use of the safety leash 10 the safety hook 15 attaches to the collar (not shown) of the animal in a known manner. Thus, the animal is secured directly to the rigid tubular member 11 of the leash 10 by connection of the safety hook 15 with the reinforced loop 14 as shown.

It will be appreciated by those skilled in the art that the animal safety leash of the present invention provides a more handler-safe leash arrangement than those provided heretofore as well as one that specifically addresses the important issue of controlling the animal at a fixed distance from the handler in congested areas and/or during instances of aggressive behavior. Further, the present safety leash provides the handler with a training aid in teaching the animal desirable leash walking habits and behaviors.

Although not specifically illustrated in the drawings, it should be understood that additional structural components will be provided as necessary, and that all of the components described above are arranged and supported in an appropriate fashion to form a complete and operative animal safety leash incorporating features of the present invention. It is also understood that variations may be made in the present invention without departing from the scope of the invention.

Moreover, although illustrative embodiments of the invention have been described, a latitude of modification, change, and substitution is intended in the foregoing disclosure, and in certain instances some features of the invention will be employed without a corresponding use of other features. Accordingly, it is appropriate that the appended claims be construed broadly and in a manner consistent with the scope of invention.

1. A safety leash for dogs and other animals comprising:
an elongated rod member of a predetermined length;
a sheath encasing said rod member closely conforming to an outer surface thereof, said sheath including hand gripping means integrally formed adjacent a proximal end of said rod member; and
an animal connecting means coupled to said rod member at a distal end thereof, said connecting means extending through said sheath and being adapted for attachment to an animal collar enabling an animal such as a dog to be held at a fixed distance from its handler corresponding to said predetermined length of said rod member.

2. The safety leash of claim 1 wherein said rod member is tubular in construction.

3. The safety leash of claim 2 wherein said rod member is constructed of aluminum.

4. The safety leash of claim 2 wherein said rod member is constructed of plastic.

5. The safety leash of claim 2 wherein said sheath is fabricated of leather.

6. The safety leash of claim 5 wherein said sheath is sewn along its length forming a longitudinal seam.

7. The safety leash of claim 2 wherein said sheath is fabricated from a woven fabric material.

8. The safety leash of claim 1 wherein said ha nd gripping means includes a continuous loop for grasping by a handler.

9. The safety leash of claim 1 wherein said connecting means includes a spring-actuated safety hook.

10. The safety leash of claim 1 wherein said predetermined length is in the range of 12 to 36 inches.
